(19) United States
(12) Patent Application Publication
(10) Pub. No.: US 2025/0299529 A1
(43) Pub. Date: Sep. 25, 2025

(54) GROUP BETTING SYSTEM AND METHOD

(71) Applicant: Bet Theory UK Ltd, London (GB)

(72) Inventors: Arya TAYEBI, London (GB); Edward GIBBS, London (GB)

(21) Appl. No.: 18/613,750

(22) Filed: Mar. 22, 2024

(51) Int. Cl. G07F 17/32

(52) U.S. Cl. CPC G07F 17/3225; G07F 17/3288

(57) ABSTRACT

Techniques are disclosed comprising receiving, at a server, an action request from a first user device to perform an action in relation to a group bet record stored in a group bet distributed cache, the group bet record being associated with the first user device and at least one additional user device. The techniques may transmit, from the server, a get request to the group bet distributed cache to retrieve the group bet record. The group bet record and a lock may be received at the server from the group bet distributed cache, based on the group bet distributed cache having determined that the lock is available. The action may be performed on the group bet record according to the action request.

### BACKGROUND

Online betting systems are known to allow individuals to place bets on different markets. When a user places a bet, details are added to an individual betting slip table, and the table gets updated with betting odds and other information about the bet, market and user. A bet assessment is undertaken prior to placement, after which the bet is accepted.

### SUMMARY

According to a first aspect of the present disclosure, there is provided a method comprising: receiving, at a group bet server, an action request from a first user device over a network to perform an action in relation to a group bet record stored in a group bet distributed cache in one or more network-based storage devices, the group bet record being associated with the first user device and at least one additional user device; transmitting, from the group bet server, a get request to the group bet distributed cache to retrieve the group bet record; receiving, at the group bet server, the group bet record and a lock, from the group bet distributed cache, based on the group bet distributed cache having determined that the lock is available; and performing the action, by the group bet server, on the group bet record according to the action request.

According to a second aspect of the present disclosure, there is provided a group bet server configured to: receiving, at the group bet server, an action request from a first user device over a network to perform an action in relation to a group bet record stored in a group bet distributed cache in one or more network-based storage devices, the group bet record being associated with the first user device and at least one additional user device; transmitting, from the group bet server, a get request to the group bet distributed cache to retrieve the group bet record; receiving, at the group bet server, the group bet record and a lock, from the group bet distributed cache, based on the group bet distributed cache having determined that the lock is available; and performing the action, by the group bet server, on the group bet record according to the action request.

According to a third aspect of the present disclosure, there is provided a system, comprising: a group bet server for performing one or more actions in relation to one or more group bet records; a group bet distributed cache for storing the one or more group bet records; wherein the system is configured to: receive, at the group bet server, an action request over a network from a first user device to perform an action in relation to a first group bet record associated with the first user device and at least one additional user device; transmit, from the group bet server, a get request to the group bet distributed cache to retrieve the first group bet record; determine, at the group bet distributed cache, if a lock is available for the first group bet record; if the lock is available, returning the first group bet record and the lock from the group bet distributed cache to the group bet server; if the lock is already in use, placing the action request in a queue at the group bet distributed cache; and if the group bet record is returned, performing the requested action at the group bet server.

According to a fourth aspect of the present disclosure, there is provided one or more non-transitory computer readable media storing instructions executable by one or more processors, wherein the instructions, when executed, cause the one or more processors to perform operations comprising: receiving, at a server, a first request from a first user device to modify a group record, the group record associated with a plurality of users and stored on one or more network-based storage devices; determining, by the server, whether the group record is currently being modified by a previous request from a second user device; modifying, using the server, the group record based at least in part on the first request, if the group record is not being modified by the second user device.

According to a fifth aspect of the present disclosure, there is provided a method comprising: receiving, at a group bet server, an action request from a first user device over a network to perform an action in relation to the group bet record stored in one or more network-based storage devices, the group bet record being associated with the first user device and at least one additional user device; transmitting, from the group bet server, a get request to the one or more network-based storage devices to retrieve the group bet record; receiving, at the group bet server, the group bet record and a lock, from the one or more network-based storage devices, if the one or more network-based storage devices have determined that the lock is available; performing the action, by the group bet server, on the group bet record according to the action request.

According to a sixth aspect of the present disclosure, there is provided a method comprising: receiving, at a group bet server, an action request from a first user device over a network to perform an action in relation to a group bet record stored in a group bet distributed cache in one or more network-based storage devices, the group bet record being associated with the first user device and at least one additional user device; transmitting, from the group bet server, a get request to the group bet distributed cache to retrieve the group bet record; receiving, at the group bet server, the group bet record from the group bet distributed cache; and performing the action, by the group bet server, on the group bet record according to the action request.

According to a seventh aspect of the present disclosure, there is provided a method for performing actions in relation to group records in a group record system, comprising: receiving, at a group record server, an action request from a first user device over a network to perform an action in relation to a group record stored in a group record distributed cache in one or more network-based storage devices, the group record being associated with the first user device and at least one additional user device; transmitting, from the group record server, a get request to the group record distributed cache to retrieve the group record; receiving, at the group record server, the group record and a lock, from the group record distributed cache, if the distributed cache has determined that the lock is available; and performing the action, by the group record server, on the group record according to the action request.

According to an eighth aspect of the present disclosure, there is provided a system for performing actions in relation to group records, comprising: a group record server for performing one or more actions in relation to one or more group records; a group record distributed cache for storing the one or more group records; wherein the system is configured to: receive, at the group record server, an action request over a network from a first user device to perform an action in relation to a first group record associated with the first user device and at least one additional user device; transmit, from the group record server, a get request to the group bet distributed cache to retrieve the first group bet record; determine, at the group record distributed cache, if a lock is available for the first group record; if the lock is available, returning the first group record and the lock from the group record distributed cache to the group record server; if the lock is already in use, placing the action request in a queue at the group record distributed cache; if the group record is returned, performing the requested action at the group record server; and push updates, by the group record server, to the first user device and the at least one additional user device regarding the action performed on the group record.

Further features and advantages of the disclosure will become apparent from the following description of preferred examples of the disclosure, given by way of example only, which is made with reference to the accompanying drawings.

### BRIEF DESCRIPTION OF THE DRAWINGS

FIG. 1 shows a system diagram for a group betting system in accordance with an example of this disclosure;

FIG. 2 shows a more detailed system diagram of the group betting system of FIG. 1;

FIG. 3 shows the layers of the stack within the group betting system of FIGS. 1 and 2, together with the different group bet record formats in accordance with an example of the disclosure;

FIG. 4 is a flow chart showing the process of creating a group bet using the system of FIGS. 1 and 2;

FIG. 5 is a flow chart showing the process of joining a group bet using the system of FIGS. 1 and 2;

FIG. 6 is a flow chart showing the process of a user leaving or deleting a group bet using the system of FIGS. 1 and 2;

FIG. 7 is a flow chart showing the process of a user taking an action to modify a draft group bet using the system of FIGS. 1 and 2;

FIG. 8 is a flow chart showing the process of a user taking an action to place a draft group bet using the system of FIGS. 1 and 2;

FIG. 9 is a flow chart showing the process of placing a group bet using the system of FIGS. 1 and 2; and

FIG. 10 shows the hierarchical group bet structure of a group bet created in accordance with the system of FIGS. 1 and 2.

### DETAILED DESCRIPTION

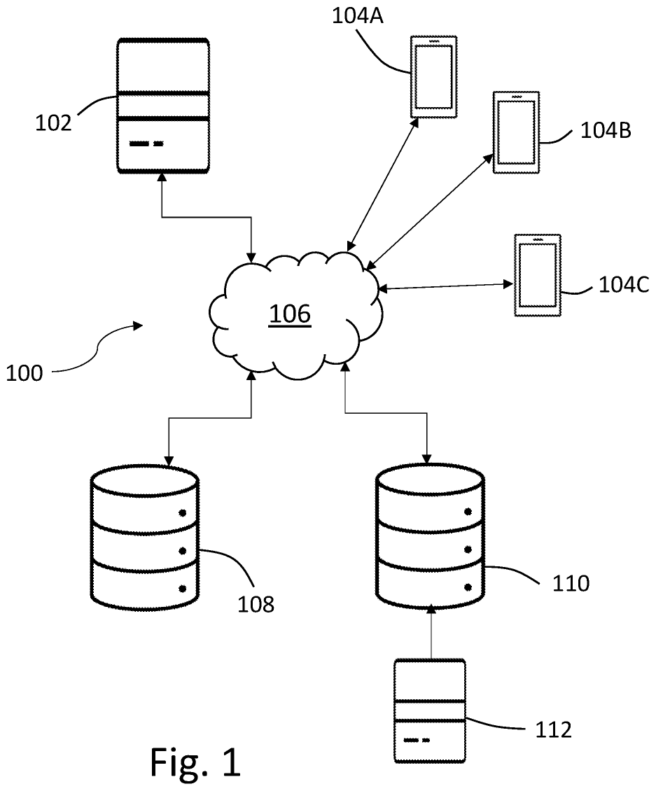

FIG. 1 shows a group betting system 100 in accordance with this disclosure. The group betting system 100 is for the creation of group bet records and for the placement of group bets. The group betting system 100 includes a group bet coordination server 102 (also referred to as a group bet server). The group bet coordination server 102 includes a plurality of modules, each configured to perform different functions in connection with group bet record generation and group bet placement. These modules will be described in more detail below. The group betting system 100 also includes a plurality of user devices 104A to 104C. These devices may be mobile/cell phones or other portable electronic devices. The group betting system 100 also includes communications network 106, that enables communication between the user devices 104A-C and the group bet coordination sever 102. In this example, three user devices are shown. It will be understood that this is not limiting on the disclosure, and in other examples any number of user devices may use the betting system 100.

The group betting system 100 also includes a distributed cache 108. The distributed cache 108 may also communicate with the group bet coordination server 102 via the communications network 106. The distributed cache 108 may be used to store draft versions of group bet records, as will be described in more detail below.

The group betting system 100 also includes a group bet database 110. The group bet database 110 performs various functions in relation to data being fed into the group bet coordination sever 102, and in relation to group bets that have been placed, as will be described below. The group bet database 110 may also be connected to the group bet coordination server 102 via the communications network 106. The group bet database 110 is configured to receive data from third party data providers, such a betting odds data provider 112, which are not part of the group betting system 100. The communications network 106 may be a single network through which all of the group betting system 100 components are connected, or it may be multiple separate networks. Elements of the group betting system 100 may be connected directly by local communications networks, depending on the local network infrastructure. The group bet database 110 may be a single database on which all data relating to the group betting system 100 is stored. Alternatively, multiple databases may be used. The group bet database 110 may be integrated within the group bet coordination server 102, or may be stored remotely.

In one example, the group bet coordination server 102 and the distributed cache 108 may be hosted in the same location, and therefore no external network is required for communication between the group bet coordination server 102 and the distributed cache 108. In this regard, the group bet coordination server 102 and the distributed cache 108 are separate instances (services), however they may be hosted in physically separate and/or remote servers, or they may be hosted in a single server in one location. They may also be hosted on separate servers, but within the same network. As such, no network may be required between them.

Users of the devices 104A-C are able to create and place group bets via the group betting system 100. A first user (also known as a creator user) may create a group bet via a chat function on the user device 104A. A draft group bet record is stored in the distributed cache 108, and other users (also known as joiner users) are invited to join the group bet. This may also be done via a chat function on the user devices 104B and 104C. Once a draft group bet has been established, any of the users may add betting selections to the group bet, after which the other users are informed. Each time the draft group bet is modified, it is retrieved from the distributed cache, modified within the group bet coordination server 102, before being returned to the distributed cache 108. Once the creator user is happy that all bets have been added, the creator user may place the group bet. However, as betting regulations often prevent an actual group bet being placed, the group bet is split into a number of individual bets; one for each user. This process and the group betting system 100 require a number of technical problems to be solved. The process and these problems will be described in more detail below.

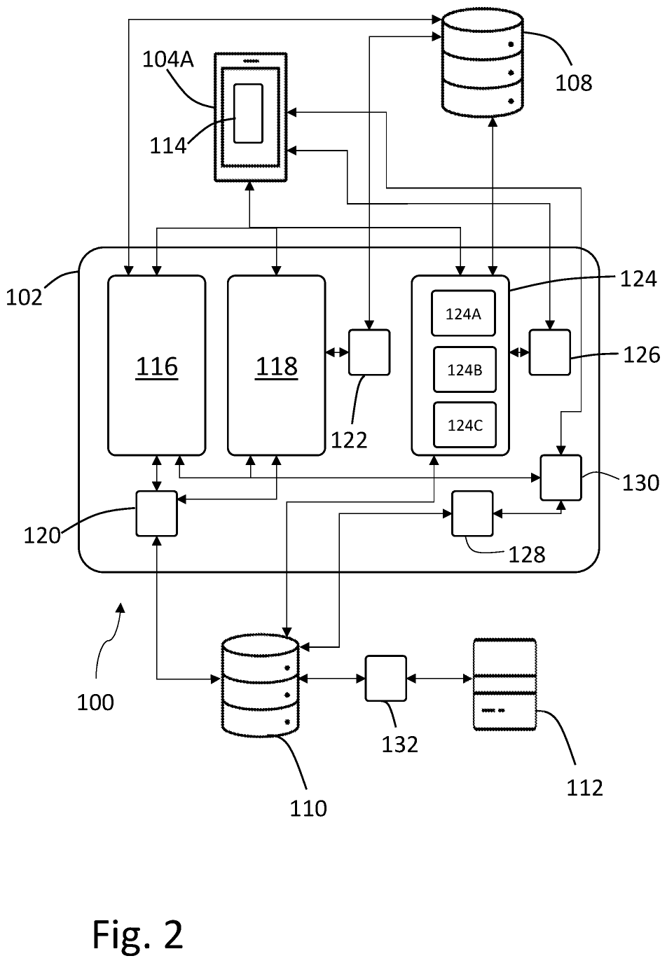

FIG. 2 shows the group betting system 100 in greater detail. A number of software applications and modules are shown, each configured to carry out different functions in relation to generation and placement of group bets. In this example, the communications network 106 is omitted for clarity. Instead, the functional connections between various components of the system are shown directly. It should be assumed that each of these functional connections is made via a suitable communications network. The user device 104A includes a betting application 114, which may include a chat function and a group bet function. The betting application 114 may be accessed and controlled though a user interface of the user device 104A. The user interface may be an interactive system through which a user communicates with and controls the functions of the user device 104A. The interface encompasses the graphical and tactile elements displayed on the device's screen, as well as the underlying software and hardware components responsible for processing user inputs and generating corresponding outputs. The disclosed user interface may include elements such as icons, buttons, menus, gestures, and touch-sensitive controls, among others, to enhance user experience and ensure optimal usability of the mobile electronic device. The betting application 114 is configured to communicate with various modules of the group bet coordination server 102, as will be described below. The other user devices 104B, 104C also include these features, however they are omitted from FIG. 2 for clarity.

The group bet coordination server 102 includes a group bet coordination module 116. The group bet coordination module 116 is configured to communicate with the betting application 114 on the user device 104A. The group bet coordination module 116 performs a number functions, including creation of group bets, joining of additional users to group bets, removal of users from group bets, and deletion of group bets.

The group bet coordination server 102 also includes a group bet modification module 118 which is for the modification of draft group bet records. The group bet modification module 118 is also configured to communicate with the betting application 114 on the user device 104A. The group bet modification module 118 is for performing different functions, including adding selections to the group bet, removing selections, and removing fixtures. These processes will be described in more detail below.

The group bet coordination server 102 also includes a user data and fund module 120 and a draft validation module 122. The user data and fund module 120 is accessible by the group bet coordination module 116 and is configured to retrieve data and fund information about users from the group bet database 110. The draft validation module 122 is for validating new and amended group bets. The draft validation module 122 is also configured to communicate with the distributed cache 108, and to provide the group bet modification module 118 with access to the distributed cache 108.

The group bet coordination server 102 also includes group bet placing modules 124, which are for placing group bets once the bets have been finalised. The group bet placing modules 124 include a placed group bet validation module 124A, a group bet assessment engine 124B and a database object builder 124C. The group bet placing modules 124 are configured to communicate with the betting application 114 and the distributed cache 108. The group bet placing modules 124 are also configured to communicate with the group bet database 110. The method of operation of the group bet placing modules 124 will be described in more detail below.

The group bet coordination server 102 also includes a validation and failure module 126, which is for validating placed group bets, and for processing any bet placement failures. The validation and failure module 126 is configured to communicate with the group bet placing modules 124 and the betting application 114.

The group bet coordination server 102 also includes data change listener module 128 and a push feed service module 130. The data change listener module 128 is configured to listen to the group bet database 110 for any changes in data, such as odds data, and to feed those updates to the push feed service module 130. The push feed service module 130 is configured to push data updates to the betting application 114.

FIG. 2 also shows a betting odds data provider 112, although this is not part of the group betting system 100. A data integration module 132 is also provided, which listens to a push feed from the betting odds data provider 112 and updates the group bet database 110 as necessary.

The distributed cache 108 includes a distributed data store and a lock mechanism which will be described in more detail below.

Some of the methods of operation of the group betting system 100 will now be described. As described above, the group bet coordination server 102 includes three main modules. These are the group bet coordination module 116, the group bet modification module 118 and the group bet placing modules 124. The group bet coordination module 116 performs all actions that relate to joining and leaving group bets. These actions may involve decisions about user fund allocations. The specific functions are creating a draft group bet record, joining a draft group bet record, leaving a draft group bet record or deleting a draft group bet record. Each of these functions are described below.

The group bet modification module 118 performs all actions that involve modification to the selections within a draft group bet. These functions include adding a selection, removing a selection, and removing a fixture. Each of these functions is described below. The group bet placing modules 124 perform the functions involved in placing a group bet. These functions are also described below.

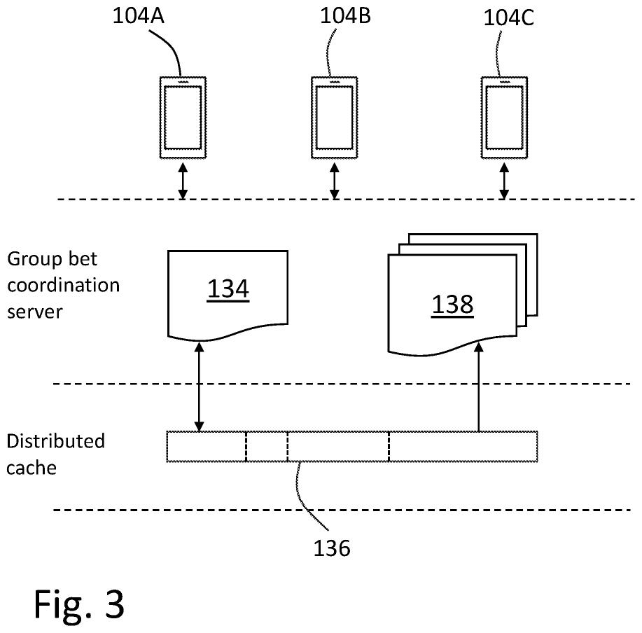

FIG. 3 shows various data records that are created and stored as part of the group betting process. The user devices 104A-C are used to create, modify and place group bets. In this example, the user of user device 104A is a first or creator user. This user may create, modify, delete or place a group bet. The user devices 104B, 104C are second and third users (or joiner users). These users may join, modify or leave a group bet. When a group bet is first placed, a draft group bet record is initially created as an in-memory object 134 in the group bet coordination server 102. It is stored here temporarily in order to create the draft group bet record. Once the record as been created, it is serialized and passed to the distributed cache 108, where is stored as a draft group bet record string 136. When a request to modify the draft group bet record is made, the draft group bet record string 136 is deserialized and returned to the group bet coordination server 102 as an in-memory object 134 for modification. Finally, when the draft group bet record is placed, the draft group bet record string 136 is established as a placed group bet record table tree 138. These steps will be described in more detail below.

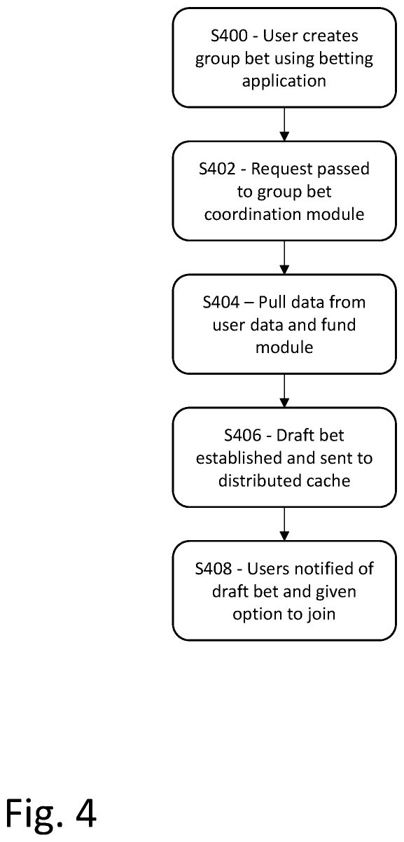

FIG. 4 shows the process of generating a group bet. Several users may be formed as group, and those users may interact via the chat function of their user devices 104A, B, C. For example, the creator user, using user device 104A, may interact with other users via a group chat established via the betting application 114. This function may be similar to chat and group chat features commonly provided in messaging applications and will not be described in detail here. The chat function of the betting application 114 includes the option to “Create group bet”, and is available to any users who are currently subscribed to the group chat. To commence the process, the creator user, selects “Create group bet” (S400). This step may include the option to specify a buy-in stake. The betting application 114 passes a request to the group bet coordination module 116 (S402). The group bet coordination module 116 pulls the necessary user data and fund information from the user data and fund module 120 (S404). As part of this process, the user data and fund module 120 reserves funds from a user account. This includes checks that the user has sufficient funds to place the bet. A draft group bet is then established as the in-memory object 134 in the group bet coordination server 102. It is then serialized and stored in the distributed cache 108 (S406) as the draft group bet record string 136. At this stage, as no selections have been made, there is no bet data. However, the group bet properties, including who created it (details of the creator user), the buy-in stake, and an ID of the group are stored. Finally, the other users in the group are notified via the group chat that the group bet has been established, giving them the option to join the bet (S408).

When first established, the draft group bet record in-memory object 134 includes the following data fields:
Group Bet Record ID;
Group ID (relating specifically to the ID of the chat group in which the group bet was created);
ID of the Creator User;
Buy-in stake and additional creator user details such as the use of any promotion specific to that user.

The specific group bet details are initially empty as no selections have been made.

The in-memory object 134 may be a C# custom object or class which contains the in-memory definition of the group bet record. It is the in-memory object which is serialized and stored in the distributed cache 108. When fetched from the distributed cache 108, the group bet record may be deserialized to a C# object in-memory. Following successful group bet placement, the in-memory object may be converted to a database object and saved using a framework such as Entity Framework Core.

In this example a user creates a group bet via the chat function. In other examples, a user may create a group bet via another channel, such as a web portal.

The distributed cache 108 may be a service such as Redis. The process of storing a draft group bet record in Redis includes the initial step of selecting an appropriate serialization format, with JSON being a popular choice due to its readability and widespread compatibility. By utilising this approach, the group bet record itself is then represented in a structured format in a single, easily accessible location. This structured representation includes information about column names to facilitate accurate reconstruction of the original group bet record object structure. Moreover, it's prudent to evaluate the size of the serialized data and, if necessary, implement compression techniques to optimize storage efficiency within the Redis cache. Redis inherently supports string compression, providing a viable option for efficiently managing large datasets.

A unique key for Redis storage may be created, and may be derived from the inherent nature of the data or through a systematic naming convention. Subsequently, the Redis SET command is employed to store the serialized string under this generated key, effectively persisting the entire table structure within the Redis cache. When retrieval is necessary, a GET command is utilized to obtain the serialized string, followed by the step of deserialization to reconstruct the group bet record original object structure for application usage. Implementing robust error-handling mechanisms may address potential issues like corrupted or improperly formatted data in the Redis cache.

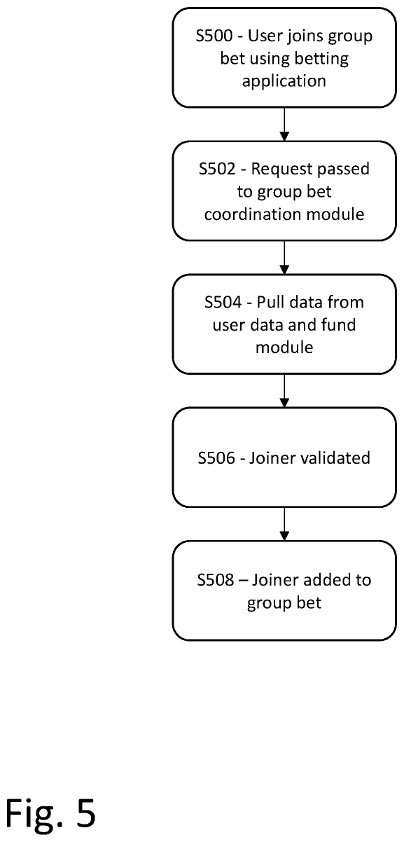

FIG. 5 shows the process of a user joining a group bet. When a joiner user sees that a group bet has been established via the chat function of their user device 104B, 104C, they are given the option to join the group bet. The process begins by a joiner user selecting “Join group bet” (S500). The betting application 114 passes a request to the group bet coordination module 116 (S502). The group bet coordination module 116 pulls the necessary user data and fund information from the user data and fund module 120 (S504). The user data and funds are validated (S506) and the joiner is the added to the draft group bet record (S508). This process includes fetching the draft group bet record string 136 (also known as a cache value) from the distributed cache 108. The draft group bet record string 136 is deserialized, edited to add the new user, serialized back to JSON, then placed back to distributed cache 108. In this example a joiner user joins a group bet via the chat function. In other examples, a user may join a group bet via another channel, such as a link in an email, a web portal etc.

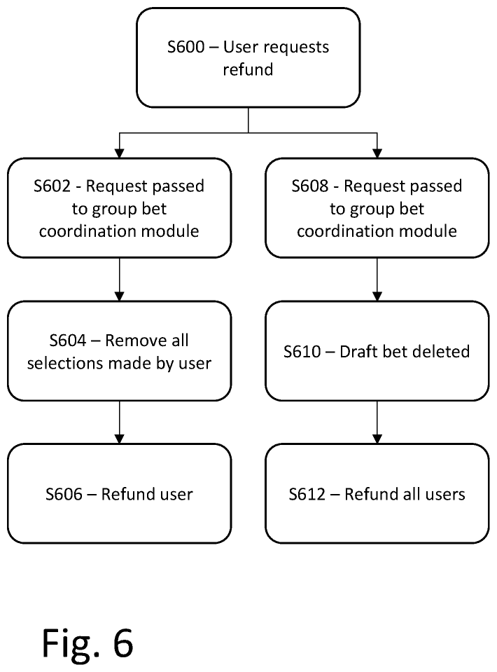

FIG. 6 shows the process of leaving or deleting a draft group bet record. Should a creator or joiner user wish to no longer be part of a draft group bet, they are given the option to either ‘Leave and refund group bet’ or ‘Delete and refund group bet’. If the creator wishes to leave a group bet, they shall be presented with the delete and refund option. If a joiner user wishes to leave a draft group bet record, they shall be presented with the leave and refund option. Following group bet placement, these options no longer remain a possibility.

As a first step, the user requests a refund by selecting the appropriate option (S600). In the case of a leave and refund request, the betting application 114 passes a request to the group bet coordination module 116 (S602). Should the request be valid, and the group bet is in a draft state, the group bet coordination module 116 removes all selections made by that individual (S604). The group bet coordination module 116 then communicates with the user data and funds module 120 to refund that user (S606). This action may be available to all users with the exception of the creator.

In the case of a delete and refund request, the betting application 114 passes a request to the group bet coordination module 116 (S608). Should the request be valid, and the group bet is in a draft state, the group bet coordination module 116 deletes the draft bet (S610). The group bet coordination module 116 then communicates with the user data and funds module 120 to refund all users (S612). This action is available to the creator only.

Once a draft group bet record string 136 has been established in the distributed cache 108, users are able to amend the draft group bet record subject to certain limitations. Both the creator user and the joiner users may make amendments. The process for making amendments will be described in the following.

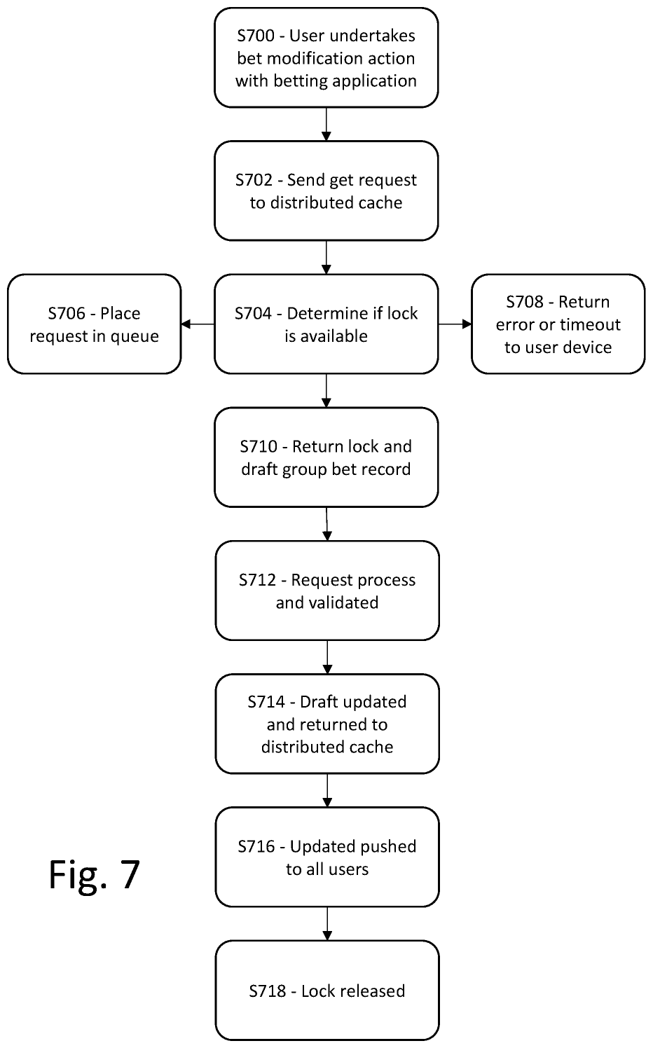

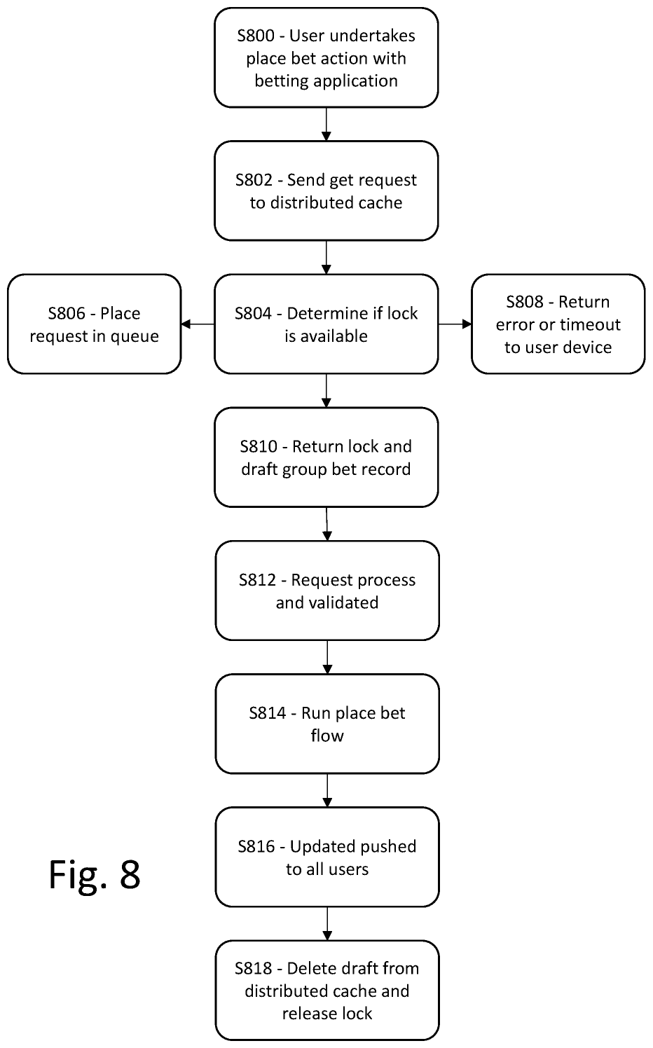

FIG. 7 shows the process flow for a user action in relation to an existing draft group bet record via the group bet modification module 118. In the context of FIG. 7, a user action may be: a) adding a selection to a draft group bet record; b) removing a selection from a draft group bet record; or c) removing a fixture from a draft group bet record. A user action may also include the placing of a bet. This will be described in connection with FIG. 8.

In the context of the present disclosure, a fixture is defined as a single event between two competitors, for example, a football match. A selection is defined as a single selection on a market in a fixture. For example, that selection may be “home team full time result”. A “bet builder” is defined as multiple selections on a single fixture. In some countries, such as the United States, this may be referred to as a “same game parlay”. As the selections are on a single fixture, they typically interact and as such, the odds for a bet builder are not just the multiplied individual selection odds. They are combined in a bet builder algorithm to give the odds for a specific combination of selections. The bet builder algorithm is not part of the present disclosure and is therefore not discussed further. By adding multiple selections or bet builders across different fixtures, an “accumulator” bet (US term “parlay”) may be created.

Adding a selection to a draft group bet record involves a user undertaking an action within the betting application 114 to make a selection on a specific fixture for incorporation into the draft group bet record. Within a group bet, two selections may not be made by different users on the same fixture. The group betting system 100 therefore undertakes validation to prevent this. Removing a selection from a draft group bet record is the opposite to the process of adding a selection. Validation is undertaking to ensure that the user is acting only on the selections that were previously added by that user. Removing a fixture from a draft group bet record is similar to the process for adding a selection, however it is not related to a specific selection. A bet builder is defined as multiple selections on a single fixture. To remove a fixture would mean to remove all selections on that fixture independent of how many selections were previously on that fixture.

In FIG. 7 the process begins with a user undertaking an action within the betting application 114 in relation to a draft group bet record (S700). In the case of a user editing a group bet, the request gets passed to the group bet modification module 118. A GET request is then sent to the distributed cache 108 by the group bet modification module 118 (S702). The lock mechanism determines if a lock is available for the draft group bet record (S704). If no lock is available, for example because another request already has the lock, the request is placed in a queue to wait for the lock to become available (S706). If the request is unable to obtain a lock, either because of an error or timeout, an error message is returned to the user (S708).

If a lock is available, it is returned to the group bet modification module 118, and the draft group bet record is made available for amendment (S710). While the request has the lock, no other request may amend the draft group bet record or place the bet. When a draft group bet record string 134 is returned from distributed cache 108 it is deserialized as the in-memory object 136 in code within the group bet coordination server 102. It may then be edited as needed.

The request is then processed and validated (S712). Validation may take different forms depending on the specific action performed by the user. In the case of an amendment to the draft group bet record, the draft validation module 122 undertakes these checks. Validation may consist of several processes. For example, it may include ensuring the data passed to the server is valid. It may also include checking that there are no conflicts with changes made by other users in earlier actions not yet propagated through to the acting user device 104A-C. Following successful validation of the request, the draft group bet record is updated and the new draft is saved back to the distributed cache (S714). Following a successful modification to the draft group bet record, an update is pushed to the user devices 104A-C of all creator and joiner users (S716) using push feed service module 130. Following any successful request, once all operations on the draft group bet record are completed and it is returned to the distributed cache 108, the lock is released, enabling other requests to make changes to the draft group bet record, or for the draft group bet record to be placed (S718).

The lock mechanism provides one solution for resolving conflicts within a distributed cache. Other conflict resolution mechanisms may be used. For example, one alternative would be for to mark the group bet records as being tracked. This would stop other requests from changing the group bet record at the same time.

FIG. 8 shows the process flow for retrieving a group bet record when the creator user places a group bet. In FIG. 8 the process begins with a user undertaking an action to place a group bet within the betting application 114 in relation to a draft group bet record (S800). In the case of the creator user placing a group bet, the request gets passed to the placed group bet validation module 124A. A GET request is then sent to the distributed cache 108 by the placed group bet validation module 124A (S802). The lock mechanism determines if a lock is available for the draft group bet record (S804). If no lock is available, for example because another request already has the lock, the request is placed in a queue to wait for the lock to become available (S806). If the request is unable to obtain a lock, either because of an error or timeout, an error message is returned to the user (S808).

If a lock is available, it is returned to the placed group bet validation module 124A, and the draft group bet record is made available for placement (S810). While the request has the lock, no other request may amendment the draft group bet record or place the bet. When the draft group bet string 134 is returned from distributed cache 108 it is deserialized as an in-memory object 136 in code within the group bet coordination server 102. The group bet may then be placed.

The request is then processed and validated (S812). Validation may take different forms depending on the specific action performed by the user. In the case of a bet placement of the draft group bet record, the validation and failure module 126 undertakes these checks. Validation may consist of several processes. For example, it may include ensuring the data passed to the server is valid. It may also include checking that there are no conflicts with changes made by other users in earlier actions not yet propagated through to the acting user device 104A-C.

After the request is validated, a place bet flow is run (S814). The placed group bet validation module 124A undertakes validation checks on the request. It is at this point when market trading status, selection trading status and odds checks are made to ensure the group bet is valid. This includes a number of steps, including validation, group bet assessment and saving to the group bet database 110, each of which will be described in more detail below. Following this, an update is pushed to the user devices of all group bet members (S816) to indicate the bet has been placed an no further modifications can be made. The draft group bet record is then deleted from the distributed cache 108 and the lock is released (S818).

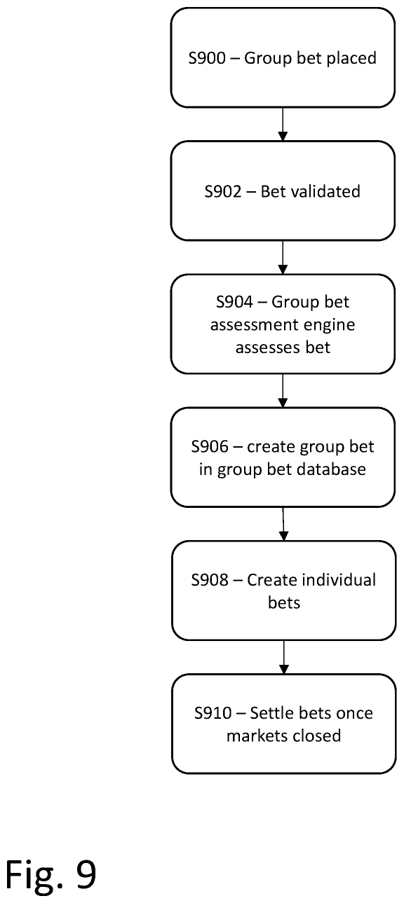

FIG. 9 shows the process for group bet placement. This is known as the place bet flow. As a first step, the bet creator places the bet (S900). One the bet has been retrieved from distributed cache 108 (as per the process described above), the placed group bet validation module 124A validates the bet (S902). This validation process involves checking the data to ensure it is valid and also determining trading statuses of each selection and current odds. Should any aspect fail validation, this shall be returned to the creator user's user device 104A, whereby they may accept the changes and place the bet for example, with the new odds. The placed group bet validation module 124A ensures data integrity and verifies user identities to prevent fraudulent activities. Its core functions encompass evaluating compliance with platform rules, including stake limits and specific event conditions, as well as dynamically calculating odds and potential payouts based on real-time event updates. The group bet assessment engine 124B then assess the group bet (S904). The group bet assessment engine 124B engages in continuous risk management, assessing factors like odds and user betting history to adjust parameters and mitigate potential losses. The group betting system 100 integrates with payment systems for seamless fund transfers, generates detailed reports for analytics-driven decision-making, and communicates bet statuses to users. The group best assessment engine 124B also ensures regulatory compliance.

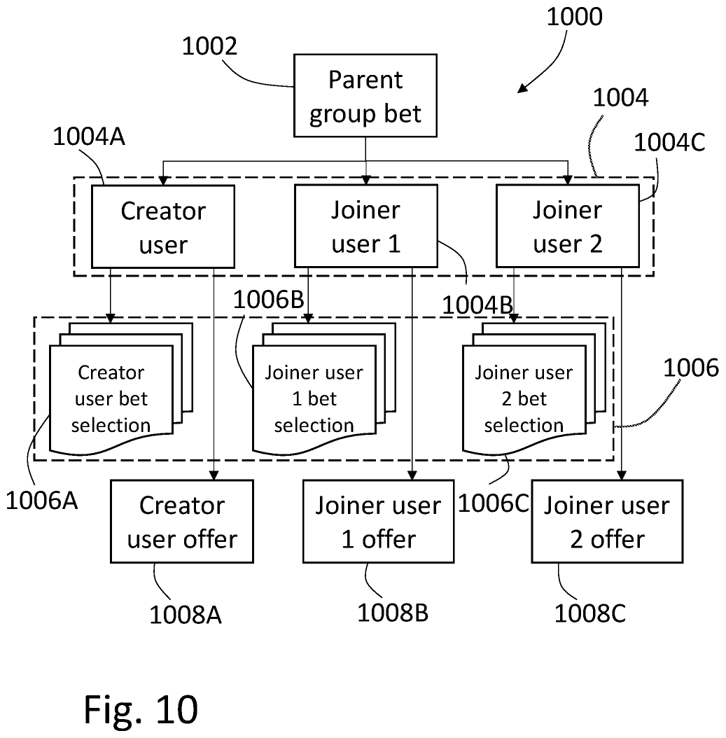

Once the group bet has passed the group bet assessment engine 124B, the database object builder 124C acts to create the placed group bet record table tree 138 in the group bet database 110 from the draft group bet (S906). The placed group bet record table tree is the finalised definition of the group bet record. The database schema is shown in FIG. 10. Because the group betting system 100 can't allow settlement of group bets, the next step is to create individual bets for each creator and joiner user of the group bet (S908). Each individual bet is then placed on behalf of the creator and joiner users, and once the market is resulted, the bets are settled accordingly (S910).

Once a group bet is placed, the system creates an individual bet for each user. These bets then behave as a regular individual bet; i.e. they are settled individually and may be cashed out by the user whenever cashout is available. This is a benefit to the user. By placing the group bet as an individual offer for each user, it gives each user personalised control whilst appearing to be a group bet. For example, when the user joins a group bet, they agree that the bet creator may place the bet at any time. There is therefore a risk that the user is will not be happy with the final bet. By creating the individual offer per user, a user may cashout their individual bet prematch for their full stake (effectively refunding their bet). This is a better user experience. This is also a good solution from a technical perspective. By creating individual offers under the group bet, the system minimizes the impact that group betting has on the wider system, as each offer may be considered in isolation.

FIG. 10 shows example structure of a group bet record 1000 (also known as the placed group bet record table tree 138) once saved into the group bet database 110. The group bet record 1000 is hierarchical in nature and consists of tables for all the relevant data. At the top level is the parent group bet table 1002. Below this a user table 1004 having a plurality of table rows 1004A, 1004B, 1004C. Below this is a selection table 1006, where each creator and joiner user has one or more selections 1006A, 1006B, 1006C. In some cases, the user may have no selections. Finally, each creator and joiner user may have an offer 1008A, 1008B, 1008C associated with them. All offers are created identical as per the placed group bet with the exception of the specific user data allowing the offer to be associated with each group bet user. The group bet record 1000 describes specifically how the group bet is defined in the group bet database 110 and the relationship between the tables. Descriptions of each table and their functions are as follows.

The parent group bet table 1002 is a parent object in the hierarchy and acts as a single point of access for all information relating to the group bet. Each group bet may have multiple group bet users and as such, there is a one-to-many relationship between the parent group bet 1002 and child group bet user. Group bet user table rows 1004A-C serve to define the creator and joiner users who participated in the group bet. As discussed above, an individual bet must be placed for each group bet user due to licensing restrictions and as such, the group bet user table rows 1004A-C act as the parent to the individual bets. There is a one-to-one relationship between the group bet users and each bet.

The bets table then follows the table structure required for placing an individual bet. As that structure does not form part of this disclosure, it is not discussed further. As the group bet user table rows 1004A-C are parent objects to the offer, it may be seen that the group bet table structure acts as a wrapper around the existing architecture of betting within the application.

Additionally, the individual user selections 1006A-C made by each group bet user are tracked for reporting purposes, and to allow an understanding of the group bet to be obtained without individually constructing the group bet from the repeated bets placed for each user. There is a one-to-many relationship between the parent group bet user and the child group bet user selection.

In the prior art, placing of group bets is generally not possible. Regulatory issues typically prevent this, requiring betting companies to arrange and settle bets with individuals. As such, in order to provide a “group bet experience”, the present disclosure implements the group bet in draft, and, only once the bet is placed are individual bets are placed on behalf of each user, with each agreeing that the bet may be placed on their behalf by the group bet creator. To achieve a draft implementation through database architecture alone would require careful control over multiple interacting database tables for any change to the draft group bet. This would result in a large amount of data repeatedly being written to and read from the tables. This would be very slow, introducing unnecessary latency into the system. This may be detected by users, which would reduce the user experience. The present disclosure provides an improved user experience by utilised a distributed cache for the storing of draft group bet records. This provides lower latency than maintaining a full tree of tables within the group bet database.

There are various technical problems which must be addressed when implementing a group betting system. These problems stem from the fact that in most jurisdictions, it is not possible for betting companies to allow groups of users to place a bet collectively. Regulations require bets to be placed by individuals. This is so that the necessary checks can be taken in connection with an individual, for example for safeguarding, and so that the betting company can manage exposure and risk in a given market. In the present system, this problem is addressed by giving users the impression that they are engaged in a group bet, when ultimately the bets are placed and settled against the individual users. If the draft group bet record were to be stored in multiple tables, this would introduce several challenges from both a technical and user experience (UX) perspective.

Repeated reading and writing to multiple joined tables is a slow process and increases load on a database. As the database is also receiving live data from the third-party data provider relating to odds, it may be preferable to minimize load on the database so that all markets within the database are accurate. This optimises the user experience as well as reducing the likelihood of betting application 114 slow-down.

Points of data in the database are single threaded, meaning that only one instance may operate at a time. Due to the number of tables involved in group betting, any data accessed must be carefully managed such that it does not get modified inadvertently in another thread whilst it is being accessed. In this database scenario, should the draft group bet be modified or deleted, a large number of tables need to be modified and tidied-up. This increases the risk of error and could lead to data corruption.

A distributed cache 108 serves as an elegant solution to this draft group bet problem. By storing the draft group bet in a singular location as a JSON serialized object, it may be quickly fetched and deserialized, significantly increasing the speed of any read or write operations. By performing all modifications to the draft group bet record in-memory, with no database actions, data conflicts become significantly easier to handle. This process represents a different use for a distributed cache. Rather than being used for the storage of static data, it is explicitly being used for dynamic data.

To minimize conflict errors and data corruption, a solution is to wrap the draft group bet record modification code in a lock. Locks can be wrapped around any code to effectively reduce that code to single-threaded access. A lock ensures that any threads wishing to access the data must enter a queue to access the data. Given that the lock is single access, it is crucial that any operations performed within it are fast. Requests are held in the queue for a specified period of time and, should a timeout occur, an error is returned to the user. Given that multiple users shall access a draft group bet record at any time, and that a large amount of computation is required to validate any changes to the draft group bet record, the solution of storing the draft group bet record in a distributed cache combined with wrapping it in a lock is an elegant solution.

Following any update to the draft group bet record, a push feed is used to instantaneously update the draft group bet definition on each user device. This further minimize the chances of conflicts and therefore improves processing time once any valid request is submitted to modify the draft group bet record.

As used in this disclosure, the term ‘user device’ pertains to a portable or non-portable electronic device capable of interacting with the system or method described herein. A user device may include, but is not limited to, smartphones, mobile phones, tablets, personal digital assistants (PDAs), laptops, desktop computers, wearable devices, and any other computing device capable of executing software applications or accessing services over a network. These devices typically comprise processors, memory, display units, input interfaces (e.g., touchscreens, keyboards, or voice recognition systems), communication modules, and other components enabling various functionalities. The user device is designed to communicate with other devices, servers, or systems to exchange data, transmit information, and perform operations as described in the examples of the present disclosure. It is to be understood that the term ‘user device’ encompasses a broad range of electronic devices utilized by individuals for personal or professional purposes.

In the context of this disclosure, the term “module” refers to a functional unit or a set of software applications designed to perform specific tasks or functions within a computer system or server. This module can encompass a single application or a collection of interconnected applications that work together to achieve a particular goal or provide a specific service. The term “module” is flexible, allowing for variations in implementation, where the applications within the module may be tightly integrated or exist as separate entities, communicating with each other as needed. Essentially, a module can be conceptual, comprising a logical grouping of software components, or it can be realized as a physical entity within a computing environment.

In the context of this disclosure, the term ‘server’ refers to a computing system or device configured to provide services, process requests, and facilitate communication within a network environment. The server may include hardware components such as processors, memory modules, storage devices, and network interfaces. Additionally, the server may run software or firmware responsible for executing various functions, managing data, and responding to client or user requests. The server may operate using standard networking protocols and may be designed to perform tasks such as data storage, computation, information retrieval, and communication. It is to be understood that the term ‘server’ encompasses a broad range of computing devices, including but not limited to, web servers, application servers, database servers, and other similar computing entities that play a role in providing, managing, or coordinating resources and services in a networked environment.

In the context of this disclosure, the term “database” refers to a structured collection of data stored in a computer system or server, organized in a manner that facilitates efficient retrieval, management, and manipulation of information. A database typically comprises one or more tables, each containing rows and columns representing individual records and attributes, respectively. These tables are interconnected through relationships, enabling the establishment of logical associations and dependencies between different sets of data. Furthermore, a database may incorporate various data management functionalities, such as querying, indexing, and transaction processing, to ensure data integrity, consistency, and accessibility. The database may be implemented using different technologies and architectures, including relational, hierarchical, network, or object-oriented models, depending on the specific requirements and characteristics of the application. Overall, a database serves as a foundational component for storing, organizing, and managing data in a structured and efficient manner, thereby supporting a wide range of applications and processes.

In the context of this disclosure, the term ‘communications network’ encompasses any interconnected system designed to facilitate the exchange of information between multiple entities, devices, or nodes. Such networks may include, but are not limited to, wired and wireless networks, local area networks (LANs), wide area networks (WANs), the Internet, intranets, cellular networks, and any other infrastructure supporting the transmission of data, signals, or messages.

The communications network may utilize various communication protocols, including wired protocols (e.g., Ethernet, USB, or fiber-optic protocols) and wireless protocols (e.g., Wi-Fi, Bluetooth, cellular, or satellite protocols). It serves as a medium for the transmission of information between devices, allowing data transfer, remote access, and communication services. Examples of communications networks encompassed within this definition include mobile phone networks, the Internet, and other interconnected systems providing means for data exchange and communication over short or long distances.

It is understood that the term ‘communications network’ is broad and inclusive, covering any system that enables the transfer of information between devices or entities in a wired or wireless fashion, and may include both current and future network technologies.

In the context of this disclosure, the term ‘distributed cache’ refers to a system or mechanism for storing and managing data in a distributed manner across multiple nodes or servers within a network. A distributed cache enhances data access speed and system performance by reducing latency and minimizing the load on individual servers.

In one example, the distributed cache may utilize an in-memory data storage model, where frequently accessed data is cached in the volatile memory of each node. This allows for rapid retrieval and reduces the need to fetch the data from the original data source, such as a database, each time it is requested.

One example of a distributed cache is Redis, an open-source, in-memory data structure store, often used as a caching mechanism and for data storage in various applications. Redis provides a distributed, key-value storage paradigm, enabling efficient data access and retrieval across a network of interconnected nodes.

It is to be understood that the term ‘distributed cache’ encompasses various implementations, configurations, and technologies beyond specific examples like Redis, and may include other distributed caching systems designed to enhance the performance and scalability of data-intensive applications.

In the context of this disclosure, the term ‘betting odds service provider’ pertains to a system or entity that offers a service facilitating the generation, distribution, and management of betting odds for various events or outcomes. The betting odds service provider may operate within the framework of a computing network, utilizing software, algorithms, and data processing capabilities to deliver accurate and up-to-date odds information to users or entities engaged in betting activities.

The betting odds service provider collects, analyses, and processes relevant data related to events, contests, or occurrences that are subject to betting. This data may include historical performance, statistics, and other relevant factors influencing the likelihood of various outcomes. The service provider employs algorithms and models to calculate and update betting odds dynamically, reflecting the perceived probabilities of different results.

The information generated by the betting odds service provider can be disseminated through various channels, such as websites, mobile applications, APIs, or other communication means. Users, including bettors, bookmakers, or other entities involved in wagering, may access and utilize the betting odds information provided by the service to inform their betting decisions.

It is to be understood that the term ‘betting odds service provider’ encompasses a broad range of systems, platforms, and technologies, and may include both centralized and distributed architectures, as well as various methods for calculating and presenting betting odds.

In the context of this disclosure, the term ‘application’ refers to a software program or executable code designed to perform specific functions or tasks on a personal electronic device. Personal electronic devices include, but are not limited to, smartphones, tablets, laptops, wearable devices, and other portable or non-portable computing devices capable of executing software.

An application may be designed for various purposes, including but not limited to, productivity, entertainment, communication, gaming, or information retrieval. Applications may encompass a single program or a suite of interconnected programs, often referred to as an ‘app’ or ‘software application.’ These applications may be pre-installed on the device or installed by the user through various distribution channels such as app stores, websites, or other online platforms.

Applications typically interact with the device's operating system and hardware components to provide a user interface, process data, and execute specific functionalities. The term ‘application’ as used herein encompasses a broad range of software programs, including native applications developed for a specific operating system, web applications accessed through a browser, and hybrid applications combining elements of both.

It is to be understood that the term ‘application’ may include software developed for diverse platforms, devices, and usage scenarios, and the patent claims should be construed to cover all such variations and implementations falling within the scope of the disclosure.

In the context of this disclosure, the term ‘function’ within an application refers to a specific operation or task performed by the software program on a personal electronic device, particularly in relation to user interface interaction and communication with a server over a network.

A ‘function’ may encompass a discrete set of operations within the application, contributing to the overall user experience. These operations may involve processing user input, displaying information on the user interface, initiating data transactions with a remote server over a network, or executing specific algorithms to achieve a predefined task.

In the context of user interface interaction, a ‘function’ may include, but is not limited to, actions such as button clicks, gestures, input forms, and navigation controls that facilitate user engagement with the application. Furthermore, the ‘function’ may involve the presentation of visual elements, data manipulation, or any other operation that contributes to the application's intended purpose.

When referring to communication with a server over a network, a ‘function’ may involve the exchange of data, requests, or responses between the application and a remote server. This may include, for example, retrieving information, updating data, or executing server-side processes that enhance the functionality of the application.

It is to be understood that the term ‘function’ within an application is versatile and encompasses various operations, features, and interactions contributing to the overall functionality and user experience. The patent claims should be interpreted to cover all aspects of these functions, whether related to user interface interactions, server communication, or any combination thereof.

Any of the techniques discussed herein, for example in relation to FIGS. 4-9, may be implemented on a system comprising one or more processors and one or more computer-readable media (e.g., non-transitory computer readable media) storing instructions that, when executed, cause the one or more processors to perform the operations of the technique(s). Any of the techniques may be implemented as one or more transitory or non-transitory computer-readable media storing instructions executable by one or more processors, wherein the instructions, when executed, cause the one or more processors to perform the operations of the technique(s). Any of the techniques may be implemented as a computer program comprising instructions which, when executed by a computer device, cause the computer device to perform the operations of the technique(s).

The above examples are to be understood as illustrative examples of the disclosure. Further examples of the disclosure are envisaged. For example, the group bet system may be a group record system, for use with the management of other types of data that require group input and approval. In this case, the group bet server may be a group record server, and the group bet distributed cache may be a group record distributed cache. The other elements of the system may also be changed accordingly. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the disclosure, which is defined in the accompanying claims.

The claims presented herein are expressed in singular dependency form. However, it is important to note that this singular form should not be interpreted as limiting the scope of the disclosure to the precise features or elements recited therein. It is intended that the features and elements described in the claims may be combined in any reasonable combination, whether explicitly stated or not, so as to encompass all variations and examples falling within the scope of the inventive concepts disclosed herein. Therefore, it is understood that the disclosure encompasses all practical combinations of the claimed features and elements, as would be apparent to those skilled in the art.

The following clauses provide further examples of the disclosure:

Clause 1. A method comprising: receiving, at a group bet server, an action request from a first user device over a network to perform an action in relation to a group bet record stored in a group bet distributed cache in one or more network-based storage devices, the group bet record being associated with the first user device and at least one additional user device; transmitting, from the group bet server, a get request to the group bet distributed cache to retrieve the group bet record; receiving, at the group bet server, the group bet record and a lock, from the group bet distributed cache, based on the group bet distributed cache having determined that the lock is available; and performing the action, by the group bet server, on the group bet record according to the action request.

Clause 2. A clause according to clause 1, further comprising: after performing the action, returning the group bet record from the group bet server to the group bet distributed cache.

Clause 3. A method according to clauses 1 or 2, further comprising: if the lock could not be obtained after a predetermined time, sending an error message to the first user device.

Clause 4. A method according to any of clauses 1 to 3, further comprising: receiving, at the group bet server, a second action request from a second user device to perform a second action in relation a second bet record; transmitting a second get request to the group bet distributed cache to retrieve the second group bet record; determining, by the group bet distributed cache, that a second lock is not available for the second group bet record; and sending an error message to the second user device.

Clause 5. A method according to any of clauses 1 to 4, further comprising: after performing the action, releasing the lock back to the group bet distributed cache.

Clause 6. A method according to any preceding clause, further comprising: validating the action request and, if the action request is valid, proceeding to perform the action; and if the action request is invalid, returning an error to the first user device.

Clause 7. A method according to any preceding clause, wherein the action request is associated with a user of the first device and is a request to update to the group bet record.

Clause 8. A method according to any of clauses 1 to 6, wherein the action request is associated with a user of the first device and is a request to run a place group bet flow.

Clause 9. A method according to clause 8, further comprising: after running the place group bet flow, establishing the group bet record in a group bet database.

Clause 10. A method according to clause 9, wherein the group bet record in the group bet database comprises a hierarchical table structure.

Clause 11. A method according to clause 10, wherein the hierarchical table structure includes a parent group bet table, a user table, and a selection table.

Clause 12. A method according to any of clauses 8 to 11, further comprising: deleting the group bet record from the group bet distributed cache after the place group bet flow has been run.

Clause 13. A method according to clause 7, further comprising: returning the updated group bet record to the group bet distributed cache after the group bet has been updated.

Clause 14. A method according to any preceding clause, wherein the group bet record stored in distributed cache is a draft record.

Clause 15. A method according to any preceding clause, wherein the group bet record is stored in distributed cache as a string, the method further comprising: prior to performing the action, deserializing the string; and after performing the action, serializing the group bet record.

Clause 16. A method according to clause 15, wherein, after the group bet record is returned from the distributed cache, the group bet record is stored in the group bet server as an in-memory object.

Clause 17. A method according to any preceding clause, further comprising: determining, at the group bet distributed cache, if the lock is available for the group bet record.

Clause 18. A method according to any preceding clause, further comprising: placing, based at least in part on determining that the lock is not available, the get request in a queue.

Clause 19. A method according to any preceding clause, further comprising: pushing an update, by the group bet sever, to the first user device and the at least one additional user device, regarding the action performed on the group bet record.

Clause 20. A system, comprising: a group bet server for performing one or more actions in relation to one or more group bet records; a group bet distributed cache for storing the one or more group bet records; wherein the system is configured to: receive, at the group bet server, an action request over a network from a first user device to perform an action in relation to a first group bet record associated with the first user device and at least one additional user device; transmit, from the group bet server, a get request to the group bet distributed cache to retrieve the first group bet record; determine, at the group bet distributed cache, if a lock is available for the first group bet record; if the lock is available, returning the first group bet record and the lock from the group bet distributed cache to the group bet server; if the lock is already in use, placing the action request in a queue at the group bet distributed cache; if the group bet record is returned, performing the requested action at the group bet server; and push updates, by the group bet server, to the first user device and the at least one additional user device regarding the action performed on the group bet record.

Clause 21. A system according to clause 20, wherein the group bet distributed cache is configured to store the group bet record as a string.

Clause 22. A system according to clauses 20 or 21, wherein the group bet server is configured to store the group bet record as an in-memory object.

Clause 23. A system according to any of clauses 20 to 22, further comprising at least one network, the at least one network configured to connect the group bet server, the group bet distributed cache, the first user device and the at least one additional user device.

Clause 24. One or more non-transitory computer readable media storing instructions executable by one or more processors, wherein the instructions, when executed, cause the one or more processors to perform operations comprising: receiving, at a server, a first request from a first user device to modify a group record, the group record associated with a plurality of users and stored on one or more network-based storage devices; determining, by the server, whether the group record is currently being modified by a previous request from a second user device; modifying, using the server, the group record based at least in part on the first request, if the group record is not being modified by the second user device.

Clause 25. A method according to any of clauses 1 to 19, wherein the steps of transmitting and receiving are done via the network.

What is claimed is:

1. A method comprising:
receiving, at a group bet server, an action request from a first user device over a network to perform an action in relation to a group bet record stored in a group bet distributed cache in one or more network-based storage devices, the group bet record being associated with the first user device and at least one additional user device;
transmitting, from the group bet server, a get request to the group bet distributed cache to retrieve the group bet record;
receiving, at the group bet server, the group bet record and a lock, from the group bet distributed cache, based on the group bet distributed cache having determined that the lock is available; and
performing the action, by the group bet server, on the group bet record according to the action request.

2. A method according to claim 1, further comprising:
after performing the action, returning the group bet record from the group bet server to the group bet distributed cache.

3. A method according to claim 1, comprising receiving, at the group bet server, the group bet record and the lock based on the group bet distributed cache having determined that the lock is available within a predetermined time.

4. A method according to claim 1, further comprising:
after performing the action, releasing the lock back to the group bet distributed cache.

5. A method according to claim 1, further comprising:
validating the action request and, if the action request is valid, proceeding to perform the action; and if the action request is invalid, returning an error to the first user device.

6. A method according to claim 1, wherein the action request is associated with a user of the first device and is a request to update to the group bet record.

7. A method according to claim 1, wherein the action request is associated with a user of the first device and is a request to run a place group bet flow.

8. A method according to claim 7, further comprising:
after running the place group bet flow, establishing the group bet record in a group bet database.

9. A method according to claim 8, wherein the group bet record in the group bet database comprises a hierarchical table structure.

10. A method according to claim 9, wherein the hierarchical table structure includes a parent group bet table, a user table, and a selection table.

11. A method according to claim 7, further comprising:
deleting the group bet record from the group bet distributed cache after the place group bet flow has been run.

12. A method according to claim 6, further comprising:
returning the updated group bet record to the group bet distributed cache after the group bet has been updated.

13. A method according to claim 1, wherein the group bet record stored in the group bet distributed cache is a draft record.

14. A method according to claim 1, wherein the group bet record is stored in the group bet distributed cache as a string, the method further comprising:
prior to performing the action, deserializing the string; and
after performing the action, serializing the group bet record.

15. A method according to claim 14, wherein, after the group bet record is returned from the distributed cache, the group bet record is stored in the group bet server as an in-memory object.

16. A method according to claim 1, further comprising: determining, at the group bet distributed cache, if the lock is available for the group bet record.

17. A method according to claim 1, further comprising: placing, based at least in part on determining that the lock is not available, the get request in a queue.

18. A method according to claim 1, further comprising: pushing an update, by the group bet sever, to the first user device and the at least one additional user device, regarding the action performed on the group bet record.

19. A system, comprising:
a group bet server for performing one or more actions in relation to one or more group bet records;
a group bet distributed cache for storing the one or more group bet records; wherein the system is configured to:
receive, at the group bet server, an action request over a network from a first user device to perform an action in relation to a first group bet record associated with the first user device and at least one additional user device;
transmit, from the group bet server, a get request to the group bet distributed cache to retrieve the first group bet record;
determine, at the group bet distributed cache, if a lock is available for the first group bet record;
if the lock is available, returning the first group bet record and the lock from the group bet distributed cache to the group bet server;
if the lock is already in use, placing the action request in a queue at the group bet distributed cache; and
if the group bet record is returned, performing the requested action at the group bet server.

20. One or more non-transitory computer readable media storing instructions executable by one or more processors, wherein the instructions, when executed, cause the one or more processors to perform operations comprising:
receiving, at a server, a first request from a first user device to modify a group record, the group record associated with a plurality of users and stored on one or more network-based storage devices;
determining, by the server, whether the group record is currently being modified by a previous request from a second user device;
modifying, using the server, the group record based at least in part on the first request, if the group record is not being modified by the second user device.
